(19) United States
(12) Patent Application Publication
(10) Pub. No.: US 2017/0149467 A1
(43) Pub. Date: May 25, 2017

(54) ELECTRONIC DEVICE AND METHOD OF MANUFACTURING A FABRIC CASING FOR AN ELECTRONIC DEVICE

(71) Applicant: Lenovo (Beijing) Limited, Beijing (CN)

(72) Inventor: Ziqiu Chen, Beijing (CN)

(21) Appl. No.: 15/087,430

(22) Filed: Mar. 31, 2016

(30) Foreign Application Priority Data
Nov. 23, 2015 (CN) 201510821288.3
Nov. 30, 2015 (CN) 201510861110.1

(51) Int. Cl. H04B 1/3888

(52) U.S. Cl. CPC H04B 1/3888

(57) ABSTRACT

Disclosed is an electronic device, including a main body; and a fabric casing comprising a connecting portion at an inner periphery of the fabric casing; wherein the fabric casing is mates with the main body via the connecting portion. Other aspects are described and claimed.

### CLAIM FOR PRIORITY

This application claims priority to Chinese Application No. 201510821288.3, filed on Nov. 23, 2015 and Chinese Application No. 201510861110.1, filed on Nov. 30, 2015, the contents of which are fully incorporated by reference herein.

### FIELD

The disclosure relates to the field of an electronic device, more particularly, to an electronic device and a manufacturing method thereof.

### BACKGROUND

With the constant development of science and technology, various electronic devices have been used more and more extensively to facilitate people's daily life and work, and become indispensable tools.

For safe use of electronic device, a casing is required for encapsulation protection. The common casing for electronic devices could be metal or plastic. The plastic casing is mostly used for its advantages of low cost, lightweight, corrosion resistance and not shielding the antenna signal.

Conventional electronic devices employ plastic casing that is typically shaped from molten state plastic material to a determined shape via a thermoplastic process, directly. However, the plastic casing made directly by a thermoplastic process presents a monotonous appearance pattern effect.

### BRIEF SUMMARY

In summary, one aspect provides an electronic device, comprising: a main body; and a fabric casing comprising a connecting portion at an inner periphery of the fabric casing; wherein the fabric casing is mates with the main body via the connecting portion.

Another aspect provides a method, the method comprising: providing a fabric material; forming a slurry layer on a surface of the fabric material to increase hardness of the fabric material; and curing the fabric material with the slurry layer.

A further aspect provides an apparatus, comprising: a fabric casing having a connecting portion at an inner periphery of the fabric casing; wherein the fabric casing mates with an electronic device body; and wherein the fabric casing comprises a fabric having a preset hardness.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 is a schematic diagram for the structure of the casing of an electronic device provided in an embodiment of the present application;

FIG. 2 is a schematic flow-chart for a manufacturing method provided in the embodiment of the present application;

FIG. 3 is a schematic flow-chart for another manufacturing method provided in the embodiment of the present application;

FIG. 4 is a schematic structural view of an electronic device provided in an embodiment;

FIG. 5 is a front view of a casing for an electronic device provided in an embodiment;

FIG. 6 is a back view of a casing for an electronic device provided in an embodiment;

FIG. 7 is a flow chart of a method for manufacturing a casing for an electronic device provided in an embodiment; and

FIG. 8 is a flow chart of a method of acquiring fabric having a preset thickness in a method for manufacturing a casing for an electronic device provided in an embodiment.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

To address the problem above, an embodiment provides an electronic device and a manufacturing method thereof, which enhances the appearance pattern effect of the casing by incorporating a texture layer.

An embodiment provides an electronic device, comprising: a casing having a predetermined hardness and a predetermined shape, the casing comprising a texture layer and a transparent layer, wherein the texture layer is made of a first material and forms a three-dimensional structure, and the transparent layer is made of a second material and allows transparency; a connecting part that is fixed inside the casing; a main body on which the casing is fixed via the connecting part.

In an embodiment, in the electronic device, the texture layer is the supporting body of the casing, and the transparent layer is the protective layer of the supporting body.

In an embodiment, in the electronic device, the texture layer comprises an outer surface facing the transparent layer and an inner surface facing away from the transparent layer, and the outer surface has a three-dimensional structure, wherein the outer surface and the transparent layer constitute the appearance effect of the casing, and the inner surface is configured to fix the connecting part.

In an embodiment, in the electronic device, the texture layer is woven from a yarn of the first material, and the yarn forms the three-dimensional structure in the weaving process, wherein the yarn is skimmed and the texture layer is processed via a hot press molding to form the predetermined hardness and the predetermined shape.

In an embodiment, in the electronic device, a manufacturing method of the casing comprises: incorporating a texture layer that is woven from the skimmed yarn and has a three-dimensional structure; processing the texture layer via a hot press molding to form a texture layer having a predetermined hardness and a predetermined shape; forming the transparent layer on the texture layer; and trimming.

In an embodiment, the electronic device further comprises an electroplated metal layer disposed between the texture layer and the transparent layer, and the electroplated metal layer is a specularly reflective layer with a determined color.

Also provided is a method for manufacturing a casing of any electronic device described above. The method comprises: preparing a yarn from a first material;

weaving the yarn into a texture layer, wherein the yarn forms the three-dimensional structure in the weaving process; processing the texture layer via a first hot press molding to form a texture layer having a predetermined hardness and a predetermined shape; forming a transparent layer on the outer surface of the texture layer, wherein the texture layer is a supporting body of the casing, and the transparent layer is a protective layer of the supporting body; and trimming the texture layer having a transparent layer on the outer surface thereof, to form the casing of the electronic device.

In an embodiment, the manufacturing method further comprises soaking the texture layer in epoxy resins to increase the hardness and toughness of the texture layer prior to the first hot press molding.

In an embodiment, the manufacturing method further comprises processing the trimmed casing of the electronic device via a second hot press molding.

In an embodiment, the manufacturing method further comprises forming an electroplated metal layer on the outer surface of the texture layer prior to the forming of the transparent layer, and the electroplated metal layer is a specularly reflective layer with a determined color.

It will be understood from the foregoing description that the electronic device provided in an embodiment comprises: a casing having a predetermined hardness and a predetermined shape, wherein the casing comprises a texture layer and a transparent layer, the texture layer is made of a first material and forms a three-dimensional structure, and the transparent layer is made of a second material and allows transparency; a connecting part that is fixed inside the casing; and a main body on which the casing is fixed via the connecting part. Thus, the casing of the electronic device described in the technical solution comprises a texture layer and a transparent layer, and the casing may have different appearance pattern effect by incorporating the three-dimensional structure of the texture layer.

The technical solution in the embodiments is described expressly and completely as follows with reference to the accompanying drawings in the embodiments of the present invention. It's clear that the embodiments described are not all but only some of the embodiments. All other embodiments obtained based on the embodiments of the present application by those of ordinary skill in the art without creative work fall within the scope of the claims.

As described in the background, conventional electronic devices employ plastic casing that is typically shaped from molten state plastic material to a determined shape directly via a thermoplastic (or curing) process. However, the plastic casing made directly by a thermoplastic process presents a monotonous appearance pattern effect.

To address the problem, an embodiment of the present application provides an electronic device comprising: a casing having a predetermined hardness and a predetermined shape, wherein the casing comprises a texture layer and a transparent layer, the texture layer is made of a first material and forms a three-dimensional structure, and the transparent layer is made of a second material and allows transparency; a connecting part that is fixed inside the casing; a main body on which the casing is fixed via the connecting part.

In an embodiment of the present application, the electronic device may be a cellphone, a tablet, etc. The connecting part is disposed on the inner surface of the casing. The connecting part may be integrally made with the casing, or made separately from the casing, and then fixed on the inner surface of the casing. The main body is the body of the electronic device, and the casing is for encapsulation protection of the body. Also, the casing may have different three-dimensional structures, which allows the electronic device to present different appearance display effects, increasing the diversity of appearance pattern. The connecting part is configured to fix the casing onto the main body.

The casing of the electronic device in an embodiment of the present application comprises a texture layer and a transparent layer, and the casing may have different appearance pattern effects by incorporating the three-dimensional structure of the texture layer. Particularly, in the electronic device of the embodiment of the present application, the first material itself defines the three-dimensional structure, and different three-dimensional structures designed with the first material results in a number of different appearance pattern effects of the casing. The casing structure of the electronic device in the embodiment of the present application is shown in FIG. 1.

FIG. 1 is the schematic diagram for the structure of the electronic device provided in an embodiment of the present application. A casing 10 comprises a texture layer 11 and a transparent layer 12. The texture layer 11 is the supporting body of the casing 10, and the transparent layer 12 is the protective layer of the supporting body.

As shown in FIG. 1, in the casing 10, the texture layer 11 comprises an outer surface 111 facing the transparent layer 12 and an inner surface 112 facing away from the transparent layer 12, and the outer surface 111 has a three-dimensional structure. The outer surface 111 and the transparent layer 12 constitute the appearance effect of the casing, and the inner surface 112 is configured to fix the connecting part.

In an embodiment of the present application, the texture layer 11 is woven from a yarn of the first material, and the yarn forms the three-dimensional structure in the weaving process, that is, the texture layer 11 is fabric and the three-dimensional structure can be designed as different three-dimensional pattern structures by designing the weaving method of the fabric, wherein the yarn is skimmed and the texture layer is processed via a hot press molding to form the predetermined hardness and the predetermined shape. Skimming the yarn can increase the toughness and strength of the fabric, and thus improves the toughness and strength of the casing. By processing the texture layer via a hot press molding, the shape and structure of the texture layer of the casing can be molded and designed with a determined size and shape, such as that of the profile of a cellphone casing or a tablet casing, and by such process, the casing can also be made with a predetermined hardness.

The texture layer 11 is woven from the yarn of the first material. The three-dimensional structure having a specific pattern structure can be formed by the material of the fabric itself. The pattern structure of the outer surface 111 is displayed through the transparent layer 12, and the inner surface 112 may be planarized via corresponding preparation processes.

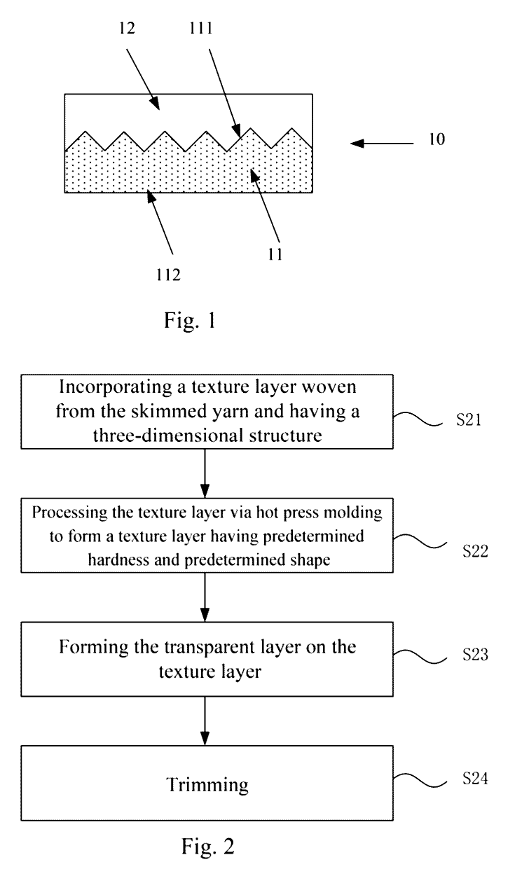

An embodiment of the present application also provides a method for manufacturing the casing shown in FIG. 1, and the method is shown in FIG. 2.

FIG. 2 is the flow-chart for a manufacturing method provided in the embodiment of the present application. The manufacturing method is for preparing the casing shown in FIG. 1 and comprises, at Step S21, incorporating a texture layer that is woven from the skimmed yarn and has a three-dimensional structure. By using the skimmed yarn, shrinkage of the yarn can be reduced, thus increasing the hardness of the texture layer. At Step S22, the method comprises processing the texture layer via a hot press molding to form a texture layer having a predetermined hardness and a predetermined shape. By processing the texture layer of the fabric via a hot press molding, the texture layer can be molded to have a determined shape and structure suitable for the casing of different electronic devices while having a predetermined hardness and a predetermined shape at the same time. At Step S23, the method comprises forming the transparent layer on the texture layer. The transparent layer may be formed by a spraying process. The transparent layer can be a UV adhesive (UV-curable adhesive). The transparent layer can enhance the stereo transparency effect of the three-dimensional structure of the texture layer.

The electronic device may optionally further comprise an electroplated metal layer disposed between the texture layer and the transparent layer, and the electroplated metal layer is a specularly reflective layer with a determined color. The electroplated metal layer is first formed on the surface of the texture layer, and the transparent layer is then prepared. That is, the casing of the electronic device in an embodiment of the present application may further comprise the electroplated metal layer capable of enhancing the stereo effect of the three-dimensional structure of the texture layer. The electroplated metal layer is a specularly reflective layer with a determined color, by which the color of the three-dimensional structure can be set, and the reflection effect thereof can also increase the luster of the three-dimensional structure. The texture layer may undergo NCVM treatment (Non-Conductive Vacuum Metallization) to form the electroplated metal layer.

At Step S24, the method comprises trimming. The trimming can be carried out by laser edging and polishing to smooth the edges of the casing.

Furthermore, the manufacturing method also comprises processing the trimmed casing of the electronic device via a second hot press molding to further cure the shape of the casing and thus mold the casing as well as increase the hardness of the casing.

It will be understood from the foregoing description that the casing of the electronic device in an embodiment of the present application comprises a texture layer having a three-dimensional structure, and the appearance of the casing presents diverse pattern effects. Also, the texture layer may be woven from the yarn of a first material, resulting in good toughness. Moreover, the texture layer is processed via a hot press molding, resulting in good hardness and determined shape. Changing the color of the first material or the color of the electroplated metal layer enables the three-dimensional structure to have different colors, which further increases the diversity of the appearance pattern.

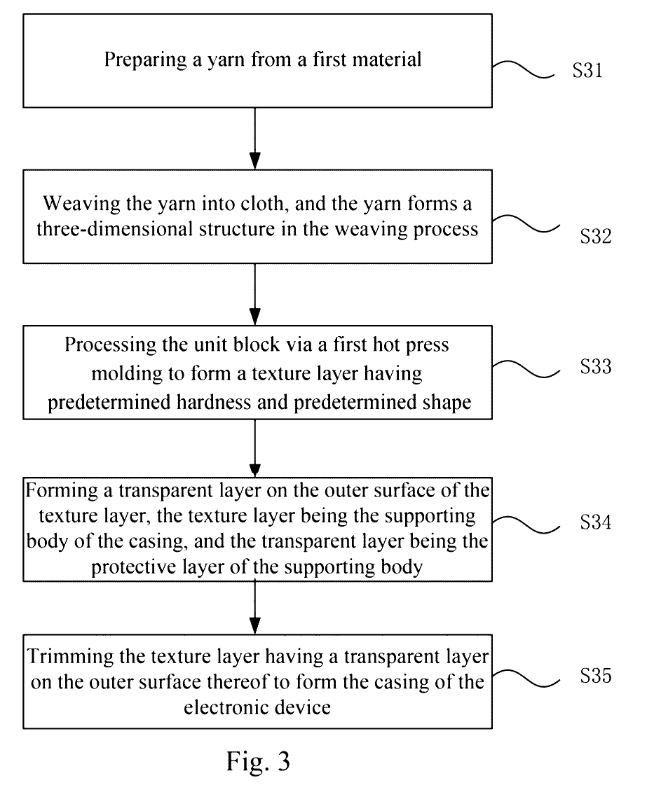

An embodiment of the present application also provides a manufacturing method for preparing a casing of the electronic device described in the embodiment above, and the manufacturing method is shown in FIG. 3. FIG. 3 is a flow-chart for another manufacturing method provided in an embodiment of the present application. and

The manufacturing method comprises, at Step S31, preparing a yarn from a first material. In an embodiment of the present application, the first material can be aramid fiber. Aramid fiber includes PET, nylon, flax, carbon fiber, polyester aramid, and glass fiber. Aramid fiber has good toughness and is of low cost. In an embodiment of the present application, the first material is preferably PET (polyethylene terephthalate plastic).

The yarn preparation process comprises: skimming the pulp of the first material, and then air drying the skimmed pulp to prepare the yarn. The skimming process increases the mechanical strength of the yarn and reduces shrinkage, which helps to increase the mechanical strength of the texture layer.

The method comprises, at Step S32, weaving the yarn into a texture layer. The yarn forms a three-dimensional structure in the weaving process. The texture layer will have different three-dimensional structures when different weaving methods are used. Changing the weaving method will change the appearance display effect of the casing.

In an embodiment of the present application, in order to improve production efficiency, a texture layer cloth of large area can be prepared, and then the texture layer cloth is cut into texture layers of small area for manufacturing the casings in an assembly line to improve production efficiency. Optionally, the texture layer cloth can be cut into multiple texture layers of small area by a laser cutting process. To avoid the yellow edges of PET caused by laser cutting that results in poor appearance, the laser output power can be set at 60W-100W, cutting with a single beam laser head at a cutting speed of 20-10000 mm/min.

The texture layer cloth or the texture layer can be soaked in epoxy resins prior to the first hot press molding. Soaking in epoxy resins can cure the yarn, increase the toughness, and prevent tearing at the same time, thus enhancing the performance of the final casing formed.

The method comprises, at Step S33. processing the texture layer via a first hot press molding to form a texture layer having a predetermined hardness and a predetermined shape. By processing via the first hot press molding, the texture layer can be molded to have a determined shape and structure suitable for the casing of different electronic devices and also to have a predetermined hardness and a predetermined shape. Also, the first hot press molding can planarize the inner surface of the texture layer to facilitate the installation of the connecting part as well as its connection and fixation with the main body of the electronic device.

At Step S34, the method comprises forming a transparent layer on the outer surface of the texture layer. The texture layer is the supporting body of the casing, and the transparent layer is the protective layer of the supporting body.

The transparent layer can be a UV adhesive. It may be formed by a spraying process. After spraying, the UV adhesive is dried at 60° C.-70° C. to retain the adhesion of the transparent layer and at the same time prevent the material from secondary crystallization and oxidation. To ensure the smoothness and uniformity of the transparent layer, the spray gun for spraying the UV adhesive is set to flat spray with 360° rotation.

Step S35: trimming the texture layer having a transparent layer on the outer surface thereof to form the casing of the electronic device.

Optionally, the manufacturing method shown in FIG. 3 may further comprise soaking the texture layer in epoxy resins to increase the hardness and toughness of the texture layer prior to the first hot press molding.

By soaking the texture layer of the fabric in epoxy resins, an epoxy resin layer can be formed on the surface of the texture layer of the fabric, allowing the texture layer to reach the predetermined thickness after the curing of the epoxy resin layer and the first hot press molding. Optionally, the manufacturing method shown in FIG. 3 may further comprise processing the trimmed casing of the electronic device via a second hot press molding to further shape the casing and increase the hardness thereof.

In an embodiment of the present application, the casing is woven from fabric having a predetermined hardness, and the texture layer of the fabric for making the casing is the supporting body of the casing, and the fabric exhibits good toughness that reduces the fracture probability of the casing when the electronic device is dropped, thus extending the service life of the electronic device and the casing thereof.

It's important to note that due to certain hardness requirements for the casing of the electronic device, in order to obtain the casing having a predetermined hardness, in an embodiment of the present application, other than soaking the texture layer of the fabric in epoxy resins to form a slurry layer on the surface thereof to improve the hardness of the casing, one may also adjust the hardness of the casing by adjusting the thickness of the fabric, i.e., in order to obtain the casing having a predetermined hardness, one may increase the thickness of the slurry layer appropriately when the thickness of the fabric is small and reduce the thickness of the slurry layer appropriately when the thickness of the fabric is large. An embodiment of the present application is illustrated by using the transparent epoxy resin as the slurry layer, and the slurry layer can also be other transparent curing materials. Depending on the circumstances, there is no limit on specific thickness for the fabric and the slurry layer, as long as the casing has the predetermined hardness.

In an embodiment of the present application, the texture layer can either be a single-ply fabric or can be formed by multiple layers of fabrics bonded together. Optionally, the thickness of the single-ply fabric is about 0.2 mm. The specific thickness can be determined according to the requirement of the electronic device.

It's also important to note that due to the complexity and high cost of the process for bonding the multiple layers of fabrics, the texture layer in the embodiment of the present application is preferably a single-ply fabric.

In an embodiment of the present application, the fabric having a predetermined hardness can be obtained by increasing the thickness of the slurry layer, and the fabric should have the required hardness for the casing of the electronic device, i.e., no deformation occurs when it's subject to certain external force, in this case, the connecting part of the casing is located around the inside of the casing and is only used for fixing and connecting the casing to the main body.

In an embodiment of the present application, when the fabric having a predefined hardness is obtained by forming a slurry layer on the surface of the fabric, but the hardness of the fabric is difficult to meet the hardness requirement for the casing of the electronic device, in this case, the connecting part is used for increasing the mechanical strength of the casing in addition to connecting the casing to the main body, so that no deformation occurs when the casing is subject to certain external force. In an embodiment, the supporting part is made of plastic, rubber, or other materials having certain hardness.

In an embodiment, the casing 10 can also be shaped by other means when the hardness of the casing does not meet the hardness requirement for the casing of the electronic device.

As described above, the method further comprises forming an electroplated metal layer on the outer surface of the texture layer prior to the forming of the transparent layer, and the electroplated metal layer is a specularly reflective layer with a determined color.

A planarized transparent layer is disposed on the surface of the casing. The transparent layer can be used as the protective layer of the texture layer and can also increase the brightness of the casing. In particular, one can see the weaving structure i.e. the three-dimensional structure of the texture layer through the transparent layer. The transparent layer can increase the brightness of the casing, further increasing the aesthetics of the appearance. The color of the texture layer can be determined by setting the color of the yarn or the color of the electroplated metal layer, which allows diverse colors for the casing.

The manufacturing method in an embodiment of the present application is of simple operation and low cost. The color of the casing prepared by this method can be determined as desired to satisfy the needs for personalization of users. The casing has the same appearance effect and strength as the ceramic casing, but the manufacturing cost of the casing is only 10% of the cost of ceramic casing.

An embodiment provides an electronic device and a method for manufacturing a casing for the electronic device, so as to improve the toughness of the casing for the electronic device and prolong the service life of the electronic device and the casing thereof.

An embodiment provides an electronic device comprising: a casing, the casing being made of fabric, the fabric fulfilling a preset hardness, and the fabric fulfilling the preset hardness forming a casing shape; a connector, the connector being fixed in the casing; and a body, the casing being fixed to the body using the connector.

In an embodiment, the fabric is ramie cotton fabric, wool fabric, or fiber fabric.

In an embodiment, a method for acquiring the fabric fulfilling the preset hardness comprises: acquiring a fabric having a preset thickness; and forming a slurry layer on a first surface of the fabric, so as to obtain the fabric fulfilling the preset hardness.

In an embodiment, the slurry layer is an epoxy resin layer.

In an embodiment, the thickness of the slurry layer ranges from about 0.1 mm to 0.2 mm, inclusive.

In an embodiment, when the fabric is ramie cotton fabric, the step of acquiring the fabric having the preset thickness comprises: acquiring a ramie cotton slurry; performing degreasing treatment and spinning on the ramie cotton slurry, so as to obtain ramie cotton yarns; binding a preset number of ramie cotton yarns to make ramie cotton threads having a preset diameter; and weaving the ramie cotton threads into a fabric having a preset thickness.

In an embodiment, the fabric fulfilling the preset hardness forming the casing shape comprises: performing thermoforming on the fabric fulfilling the preset hardness, so that the fabric fulfilling the preset hardness forms a casing shape prototype; and performing trimming and polishing on the casing shape prototype of the fabric fulfilling the preset hardness, so that the fabric fulfilling the preset hardness forms the casing shape.

In an embodiment, after performing trimming and polishing on the casing shape prototype of the fabric fulfilling the preset hardness, the following step further comprises: forming a transparent paint layer on a second surface of the fabric fulfilling the preset hardness, the second surface being a surface opposite to the first surface.

In an embodiment, the transparent paint layer is a UV paint layer.

Also provided is a method for manufacturing a casing for an electronic device. The method comprises: acquiring a fabric having a preset thickness; and forming a slurry layer on a first surface of the fabric, so as to obtain the fabric fulfilling the preset hardness; performing thermoforming on the fabric fulfilling the preset hardness, so that the fabric fulfilling the preset hardness forms a casing shape prototype; and performing trimming and polishing on the casing shape prototype of the fabric fulfilling the preset hardness, so that the fabric fulfilling the preset hardness forms the casing shape.

In an embodiment, the fabric is ramie cotton fabric, wool fabric, or fiber fabric.

In an embodiment, when the fabric is ramie cotton fabric, the step of acquiring the fabric having the preset thickness comprises: acquiring a ramie cotton slurry; performing degreasing treatment and spinning on the ramie cotton slurry, so as to obtain ramie cotton yarns; binding a preset number of ramie cotton yarns to make ramie cotton threads having a preset diameter; and weaving the ramie cotton threads into a fabric having a preset thickness.

In an embodiment, after performing trimming and polishing on the casing shape prototype of the fabric fulfilling the preset hardness, the following step further comprises: forming a transparent paint layer on a second surface of the fabric fulfilling the preset hardness, the second surface being a surface opposite to the first surface.

In an embodiment, the transparent paint layer is a UV paint layer.

In an embodiment, the slurry layer is an epoxy resin layer.

In an embodiment, the thickness of the slurry layer ranges from about 0.1 mm to 0.2 mm, inclusive.

In an embodiment, an electronic device comprises: a body, a connector, and a casing fixed to the body using the connector. The casing is made of fabric, the fabric fulfills a preset hardness, the fabric fulfilling the preset hardness forms a casing shape, and the fabric is of good malleability, reducing the probability of breaking the casing when the electronic device falls, thereby prolonging the service life of the electronic device and the casing thereof

Plastic casing in the prior art is of poor malleability, and when the electronic device falls, the plastic casing is easily broken, leading to a short service life for the electronic device and the casing thereof.

Therefore, an embodiment provides an electronic device, comprising: a casing, the casing being made of fabric, the fabric fulfilling a preset hardness, and the fabric fulfilling the preset hardness forming a casing shape; a connector, the connector fixed in the casing; and a body, the casing being fixed to the body using the connector.

Correspondingly, an embodiment provides a method for manufacturing a casing for an electronic device, comprising: acquiring a fabric having a preset thickness; forming a slurry layer on a first surface of the fabric, so as to obtain the fabric fulfilling the preset hardness; performing thermoforming on the fabric fulfilling the preset hardness, so that the fabric fulfilling the preset hardness forms a casing shape prototype; and performing trimming and polishing on the casing shape prototype of the fabric fulfilling the preset hardness, so that the fabric fulfilling the preset hardness forms the casing shape.

In the electronic device and the method for manufacturing a casing thereof provided in embodiments, the casing is made of fabric, the fabric fulfills a preset hardness, the fabric fulfilling the preset hardness forms a casing shape, and the fabric is of good malleability, reducing the probability of breaking the casing when the electronic device falls, thereby prolonging the service life of the electronic device and the casing thereof.

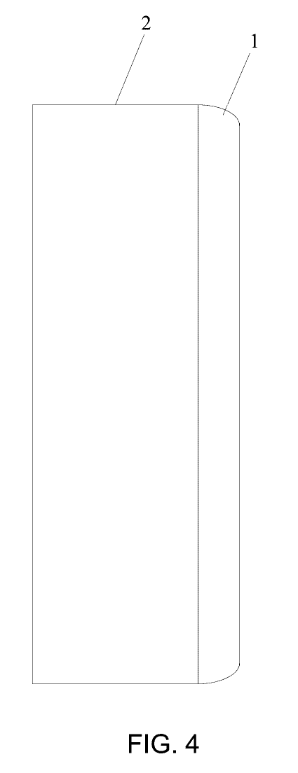

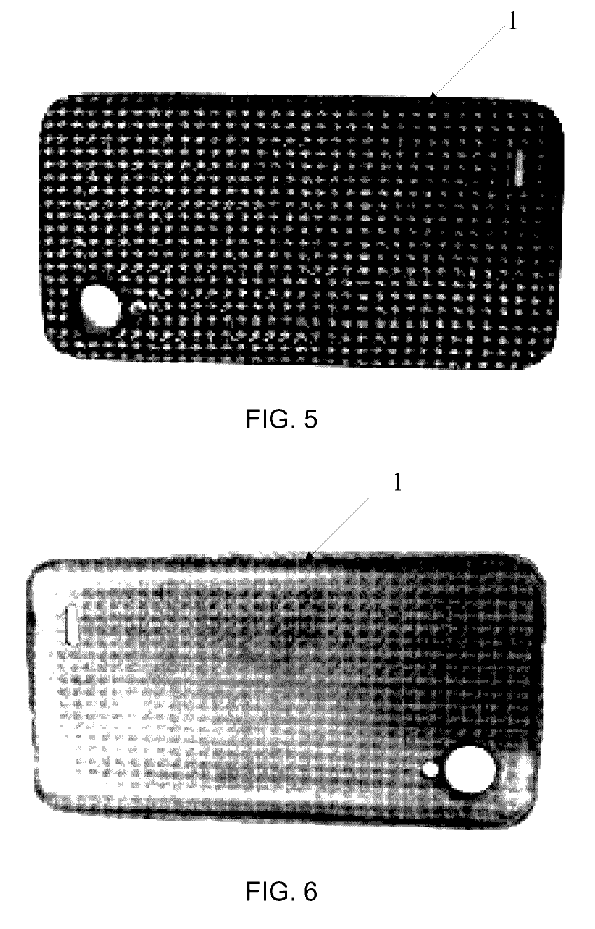

An embodiment of the present invention provides an electronic device, as shown in FIG. 4, the electronic device comprises: a casing 1, as shown in FIG. 5 and FIG. 6, the casing 1 being made of fabric, the fabric fulfilling a preset hardness, and the fabric fulfilling the preset hardness forming a casing shape; a connector (not shown), the connector being fixed in the casing 1; and a body 2, the casing 1 being fixed to the body 2 using the connector.

On the basis of the above embodiment, in an embodiment, the fabric is ramie cotton fabric. In another embodiment, the fabric is wool fabric. In still another embodiment, the fabric is fiber fabric, and in other embodiments, the fabric may be fabrics of other materials.

In an embodiment, a method of acquiring the fabric fulfilling the preset hardness comprises: acquiring fabric having a preset thickness; and forming a slurry layer on a first surface of the fabric, to obtain the fabric fulfilling the preset hardness, so that the fabric has a fixed shape. In an embodiment, the slurry layer is an epoxy resin layer. In another embodiment, the slurry layer may further be a layer of another material, as long as it can improve the hardness of the fabric, depending on specific situations.

It should be noted that, the casing for the electronic device has a certain hardness requirement and in order to obtain the casing fulfilling the preset hardness, in an embodiment, in addition to forming the slurry layer on the surface of the fabric to improve the hardness of the casing, the hardness of the casing may be further adjusted by adjusting the thickness of the fabric. That is, in order to obtain the casing fulfilling the preset hardness, when the fabric is relatively thin, the thickness of the slurry layer may be increased appropriately, and when the fabric is relatively thick, the thickness of the slurry layer may be reduced appropriately. As long as the casing fulfills the preset hardness, the specific thickness of the fabric and the specific thickness of the slurry layer are not limited in the present invention and depend on specific situations.

In an embodiment, the preset thickness ranges from about 0.2 mm to 0.6 mm, and the thickness of the slurry layer ranges about 0.1 mm to 0.2 mm, inclusively. In an embodiment, the thickness of the slurry layer is about 0.2 mm.

By using ramie cotton fabric as an example, the method of acquiring the fabric having the preset thickness in the embodiment of the present invention is described. On the basis of any one of the above embodiments, in an embodiment, when the fabric is ramie cotton fabric, the step of acquiring the fabric having the preset thickness comprises: acquiring a ramie cotton slurry; performing degreasing treatment and spinning on the ramie cotton slurry, so as to obtain ramie cotton yarns; binding a preset number of ramie cotton yarns to make ramie cotton threads having a preset diameter; and weaving the ramie cotton threads into a fabric having a preset thickness.

It should be noted that, in an actual application, the weaving of the ramie cotton into a fabric having a preset thickness comprises: weaving by using the ramie cotton threads to obtain fabric having a single layer thickness, where the thickness of the fabric having the single layer thickness is about 0.2 mm. When the preset thickness is equal to the single layer thickness, the ramie cotton threads are used for weaving directly, so as to obtain the thickness having the preset thickness; when the preset thickness is greater than the single layer thickness, the ramie cotton threads need to be used for weaving first to obtain the fabric having the single layer thickness, and multiple layers of the fabric having the single layer thickness are overlapped together and then laminated, thereby obtaining the fabric having the preset thickness.

It should be further noted that, the process of overlapping and laminating the multiple layers of the fabric having the single layer thickness is complicated and is high in cost; therefore, on the basis of the above embodiments, in an embodiment, the fabric having the preset thickness is preferably the fabric having the single layer thickness. In an embodiment, the fabric fulfilling the preset hardness may be obtained by increasing the thickness of the slurry layer, and the hardness of the fabric can meet the requirement of the electronic device on the casing hardness. That is, the casing will not deform when applying a certain degree of external force. In this casing, the connector is located at the periphery of the interior of the casing 1, and is merely used to fixedly connect the casing 1 and the body. In an embodiment, after the slurry layer is formed on the surface of the fabric to obtain the fabric having the preset hardness, the hardness of the fabric cannot meet the requirement of the electronic device on the casing hardness, and in this casing, the connector comprises: a connecting portion located at the periphery of the interior of the casing 1 and a supporting portion located at the bottom surface of the interior of the casing 1, the supporting portion forms the shape of the casing 1, so that the supporting portion supports the casing 1 and fixes the shape of the casing 1; therefore, the casing will not be deformed when applying a certain degree of external force. In an embodiment, the supporting portion may be plastic, may also be rubber, and may also be other materials having a certain hardness.

In an embodiment, when the hardness of the casing 1 does not meet the requirement of the electronic device on the hardness of the casing thereof, the shape of the casing 1 may be further fixed in other manners.

In an embodiment, the fabric fulfilling the preset hardness forming the casing shape comprises: performing thermoforming on the fabric fulfilling the preset hardness, so that the fabric fulfilling the preset hardness forms a casing shape prototype; and performing trimming and polishing on the casing shape prototype of the fabric fulfilling the preset hardness, so that the fabric fulfilling the preset hardness forms the casing shape.

It should be noted that, in an embodiment, the area of the fabric fulfilling the preset hardness corresponds to the area of the casing of one electronic device. In other embodiments, to facilitate batch production of casings of electronic devices, the area of the fabric fulfilling the preset hardness may also correspond to the area of casings of multiple electronic devices. In an embodiment, the fabric fulfilling the preset hardness forming the casing shape comprises: dividing the fabric fulfilling the preset hardness into multiple fabric units fulfilling the preset hardness, the area of each fabric unit fulfilling the preset hardness corresponding to the area of the casing of one electronic device; performing thermoforming on the fabric unit fulfilling the preset hardness, so that the fabric unit fulfilling the preset hardness forms a casing shape prototype; and performing trimming and polishing on the casing shape prototype of the fabric unit fulfilling the preset hardness, so that the fabric unit fulfilling the preset hardness forms the casing shape.

In an embodiment, after performing trimming and polishing on the casing shape prototype of the fabric fulfilling the preset hardness, the following step further comprises: forming a transparent paint layer on a second surface of the fabric fulfilling the preset hardness, the second surface being a surface opposite to the first surface. In an embodiment, the transparent paint layer is not only further able to improve the hardness of the casing, but is also able to further enhance the three-dimensional display effect of the casing. Moreover, the transparent paint layer may further improve the smoothness of the second surface. In an embodiment, the transparent paint layer is a UV paint layer.

In the electronic device provided in an embodiment, the casing is made of fabric, the fabric fulfills a preset hardness, the fabric fulfilling the preset hardness forms a casing shape, and the fabric is of good malleability, which not only reduces the probability of breaking the casing when the electronic device falls, but also improves the abrasion resistance of the casing, thereby prolonging the service life of the electronic device and the casing thereof.

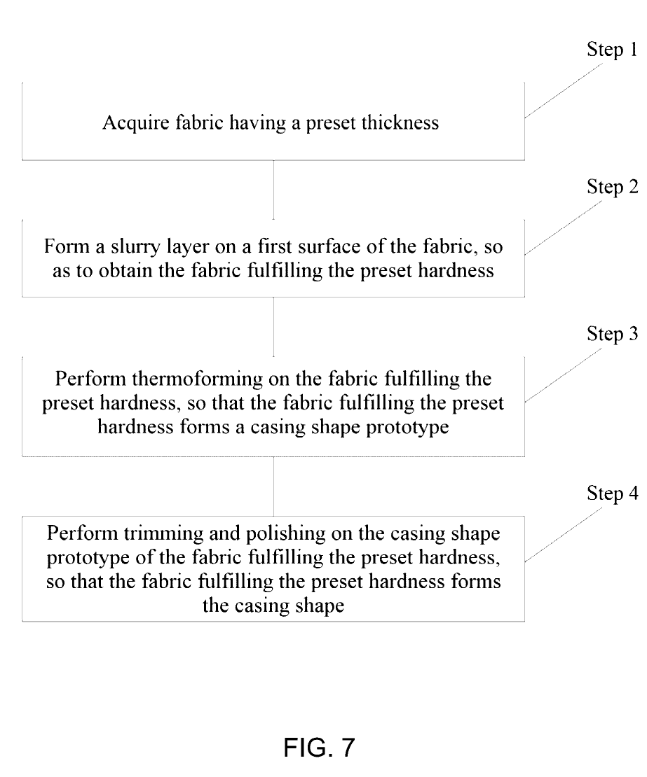

Correspondingly, an embodiment further provides a method for manufacturing a casing for an electronic device, as shown in FIG. 7, the method comprises:

Step 1: Acquire fabric having a preset thickness. In an embodiment of the present invention, a method of acquiring the fabric fulfilling the preset hardness comprises: acquiring fabric having a preset thickness; and forming a slurry layer on a first surface of the fabric, to obtain the fabric fulfilling the preset hardness, so that the fabric has a fixed shape. In an embodiment, the slurry layer is an epoxy resin layer. In an embodiment, the slurry layer may further be a layer of another material, as long as it can improve the hardness of the fabric, depending on specific situations.

Step 2: Form a slurry layer on a first surface of the fabric, so as to obtain the fabric fulfilling the preset hardness.

It should be noted that, the casing for the electronic device has a certain hardness requirement, in order to obtain the casing fulfilling the preset hardness, in an embodiment, in addition to forming the slurry layer on the surface of the fabric to improve the hardness of the casing, the hardness of the casing may further be adjusted by adjusting the thickness of the fabric. That is, in order to obtain the casing fulfilling the preset hardness, when fabric is relatively thin, the thickness of the slurry layer may be increased appropriately, and when the fabric is relatively thick, the thickness of the slurry layer may be reduced appropriately. As long as the casing fulfills the preset hardness, the specific thickness of the fabric and the specific thickness of the slurry layer are not limited and depend on specific situations.

In an embodiment, the preset thickness ranges from about 0.2 mm to 0.6 mm, and the thickness of the slurry layer preferably ranges from about 0.1 mm to 0.2 mm, inclusively. In an embodiment, the thickness of the slurry layer is about 0.2 mm.

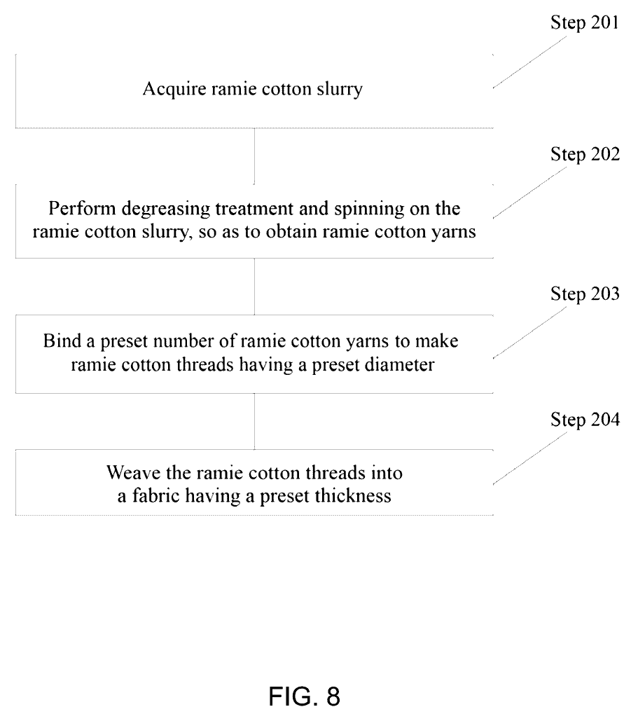

By using ramie cotton fabric as an example, the method of acquiring the fabric having the preset thickness in an embodiment is described. In an embodiment, when the fabric is ramie cotton fabric, as shown in FIG. 8, the step of acquiring the fabric having the preset thickness comprises:

Step 201: acquiring a ramie cotton slurry;

Step 202: performing degreasing treatment and spinning on the ramie cotton slurry, so as to obtain ramie cotton yarns;

Step 203: binding a preset number of ramie cotton yarns to make ramie cotton threads having a preset diameter; and

Step 204: weaving the ramie cotton threads into a fabric having a preset thickness.

It should be noted that, in an actual application, the weaving of ramie cotton threads into the fabric having a preset thickness comprises: weaving by using the ramie cotton threads to obtain fabric having a single layer thickness, where the thickness of the fabric having the single layer thickness is about 0.2 mm. When the preset thickness is equal to the single layer thickness, the ramie cotton threads are used for weaving directly, so as to obtain the thickness having the preset thickness; when the preset thickness is greater than the single layer thickness, the ramie cotton threads need to be used for weaving first to obtain the fabric having the single layer thickness, and multiple layers of the fabric having the single layer thickness are overlapped together and then laminated, thereby obtaining the fabric having the preset thickness.

Step 3: Perform thermoforming (or curing) on the fabric fulfilling the preset hardness, so that the fabric fulfilling the preset hardness forms a casing shape prototype.

It should be noted that, in an embodiment, the area of the fabric fulfilling the preset hardness corresponds to the area of the casing of one electronic device. In an embodiment, to facilitate batch production of casings of electronic devices, the area of the fabric fulfilling the preset hardness may also corresponds to the area of casings of multiple electronic devices. In an embodiment, before performing thermoforming on the fabric fulfilling the preset hardness, the following steps further comprise: dividing the fabric fulfilling the preset hardness into multiple fabric units fulfilling the preset hardness, the area of each fabric unit fulfilling the preset hardness corresponding to the area of the casing of one electronic device; and performing thermoforming on the fabric unit fulfilling the preset hardness, so that the fabric unit fulfilling the preset hardness forms a casing shape prototype. However, this is not limited in the present invention and depends on specific situations.

Step 4: Perform trimming and polishing on the casing shape prototype of the fabric fulfilling the preset hardness, so that the fabric fulfilling the preset hardness forms the casing shape. In an embodiment, the trimming process is a laser trimming process.

In an embodiment, after performing trimming and polishing on the casing shape prototype of the fabric fulfilling the preset hardness, the following step further comprises: forming a transparent paint layer on a second surface of the fabric fulfilling the preset hardness, the second surface being a surface opposite to the first surface. In this embodiment, the transparent paint layer is not only further able to improve the hardness of the casing, but is also able to further enhance the three-dimensional display effect of the casing. Moreover, the transparent paint layer may further improve the smoothness of the second surface. In an embodiment, the transparent paint layer is a UV paint layer, but this is not limited in the present invention and depends on specific situations.

It should be noted that, after the casings are manufactured and before the casings are transported to manufacturers of electronic devices for assembling, the casings are further detected and screened, where qualified casings are packaged to be transported to manufacturers of the electronic devices, and unqualified casings are not packaged and transported. Detection and packaging steps are well-known by persons skilled in the art; therefore, are not described in detail in the present application.

In an embodiment, the casing is made of fabric, the fabric fulfills a preset hardness, the fabric fulfilling the preset hardness forms a casing shape, and the fabric is of good malleability, which not only reduces the probability of breaking the casing when the electronic device falls, but also improves the abrasion resistance of the casing, thereby prolonging the service life of the electronic device and the casing thereof.

Various parts in the specification are described in a progressive manner, each part emphasizes a portion different from other parts, and identical or similar portions of the parts may be obtained with reference to each other.

A person skilled in the art should be able to implement or use the invention, after reading the description of the embodiments disclosed above. Various modifications of these embodiments would be apparent to a person skilled in the art, the general principle defined herein can also be implemented in other embodiments without departing from the spirit or scope of the present disclosure. Accordingly, the present disclosure will not be limited to the embodiments demonstrated herein, but encompass the broadest scope that is consistent with the principle and novelty disclosed herein.

What is claimed is:

1. An electronic device, comprising:
a main body; and
a fabric casing comprising a connecting portion at an inner periphery of the fabric casing;
wherein the fabric casing is mates with the main body via the connecting portion.

2. The electronic device of claim 1, wherein the fabric is selected from the group consisting of ramie cotton fabric, wool fabric, and fiber fabric.

3. The electronic device of claim 1, wherein the fabric casing comprises a fabric having a preset hardness.

4. The electronic device of claim 3, wherein the fabric having the preset hardness comprises:
a fabric having a preset thickness; and
a slurry layer on a first surface of the fabric.

5. The electronic device of claim 4, wherein the slurry layer comprises epoxy resin.

6. The electronic device of claim 5, wherein the thickness of the slurry layer ranges from about 0.1 mm to 0.2 mm, inclusive.

7. The electronic device of claim 3, wherein the fabric having a preset hardness is obtained by a method comprising:
acquiring a ramie cotton slurry;
performing degreasing treatment and spinning on the ramie cotton slurry, so as to obtain ramie cotton yarns;
binding a preset number of ramie cotton yarns to make ramie cotton threads having a preset diameter; and
weaving the ramie cotton threads into a fabric having a preset thickness.

8. The electronic device of claim 1, wherein the fabric casing is obtained by a method comprising:
performing thermoforming on a fabric with a preset hardness, wherein the fabric with a preset hardness forms a casing shape prototype; and
performing trimming and polishing on the casing shape prototype to form the fabric casing.

9. The electronic device of claim 8, wherein the method further comprises:
forming a transparent paint layer on a second surface of the fabric with the preset hardness, the second surface being a surface opposite to the first surface.

10. The electronic device of claim 9, wherein the transparent paint layer is a UV paint layer.

11. A method, the method comprising:
providing a fabric material;
forming a slurry layer on a surface of the fabric material to increase hardness of the fabric material; and
curing the fabric material with the slurry layer.

12. The method of claim 11, wherein the fabric is selected from a group consisting of ramie cotton fabric, wool fabric, and fiber fabric.

13. The method of claim 11, wherein the cured fabric material has a preset hardness.

14. The method of claim 13, the step of providing a fabric comprises:
acquiring a ramie cotton slurry;
performing degreasing treatment and spinning on the ramie cotton slurry, so as to obtain ramie cotton yarns;
binding a preset number of ramie cotton yarns to make ramie cotton threads having a preset diameter; and
weaving the ramie cotton threads into a fabric having a preset thickness.

15. The method of claim 11, further comprising:
forming a transparent paint layer on a second surface of the fabric, the second surface being a surface opposite to the first surface.

16. The method of claim 15, wherein the transparent paint layer is a UV paint layer.

17. The method of claim 11, wherein the slurry layer comprises an epoxy resin.

18. The method of claim 11, wherein the thickness of the slurry layer ranges from about 0.1 mm to 0.2 mm, inclusive.

19. An apparatus, comprising:
a fabric casing having a connecting portion at an inner periphery of the fabric casing;
wherein the fabric casing mates with an electronic device body; and
wherein the fabric casing comprises a fabric having a preset hardness.

20. The apparatus of claim 19, wherein the fabric having the preset hardness comprises:
a fabric having a preset thickness; and
a slurry layer on a first surface of the fabric.
